(19) United States
(12) Patent Application Publication
(10) Pub. No.: US 2019/0027968 A1
(43) Pub. Date: Jan. 24, 2019

(54) WIRELESS POWER TRANSMITTER AND RECEIVER

(71) Applicant: LG INNOTEK CO., LTD., Seoul (KR)

(72) Inventor: Sung Hyun LEEM, Seoul (KR)

(73) Assignee: LG INNOTEK CO., LTD., Seoul (KR)

(21) Appl. No.: 16/068,327

(22) PCT Filed: Dec. 9, 2016
(86) PCT No.: PCT/KR2016/014455

§ 371 Date: Jul. 5, 2018

(30) Foreign Application Priority Data
Jan. 6, 2016 (KR) 10-2016-0001502
Jan. 6, 2016 (KR) 10-2016-0001548

(51) Int. Cl. H02J 50/12; H01F 27/28

(52) U.S. Cl. CPC H02J 50/12; H01F 27/28

(57) ABSTRACT

A wireless power transmitter, which transfers wireless power to a wireless power receiver, according to an embodiment includes: a power supply unit; a transfer coil unit including a plurality of transfer coils, which are connected to each other to form one body and have sizes different from each other; and a control unit configured to detect a size of a receiver coil of the wireless power receiver and determine one transfer coil for transferring the wireless power to the receiver coil among the plurality of transfer coils on the basis of the size of the receiver coil.

### TECHNICAL FIELD

The present invention relates to a wireless power transmitter and a wireless power receiver.

### BACKGROUND ART

Generally, various electronic equipment include a battery and is driven by using power charged in the battery. Here, in the electronic equipment, the battery may be replaced and rechargeable. For this, the electronic equipment include a contact terminal coming into contact with an external charging device. That is, the electronic equipment is electrically connected to the charging device through the contact terminal. However, since the contact terminal of the electronic equipment is exposed to the outside, the contact terminal may be contaminated by foreign objects or short-circuited by moisture. In this case, contact failure may occur between the contact terminal and the charging device, and thus, the battery may not be charged in the electronic equipment.

To solve the above-described problem, a wireless power transfer (WPT) for wirelessly charging the electronic equipment has been proposed.

A wireless power transfer system is a technology that transfers power without a line through a space and maximizes convenience of power supply to mobile devices and digital household appliances.

The wireless power transfer system has advantages such as saving energy through real-time power usage control, overcoming a space limitation of the power supply, and reducing waste battery discharge through the recharging of the battery.

As a method for implementing the wireless power transfer system, there are typically a magnetic induction method and a magnetic resonance method. The magnetic induction method is a noncontact energy transfer technique in which two coils are close to each other, and current flows to one coil, and thus, electromotive force is generated in the other oil by using a magnetic flux generated thereby as a medium. Here, frequency of several hundred KHz may be used. The magnetic resonance method is a magnetic resonance technique that uses only electric fields or magnetic fields without using electromagnetic waves or current. Thus, a distance over which power is capable of being transferred may be several meters or more, and a band of several MHz may be used.

The wireless power transfer system includes a transfer device wirelessly transferring power and a receiver device receiving power to charge a load such as a battery. Here, a charging method of the receiver device, i.e., one charging method of the magnetic induction method or the magnetic resonance method may be selected, and a power transfer device for wirelessly transferring power to correspond to the charging method of the receiver device is being developed.

### DISCLOSURE OF THE INVENTION

### Technical Problem

A wireless power transmitter including a plurality of transfer coils according to an embodiment detects a size of a receiver coil of a wireless power receiver and selects one transfer coil of the plurality of transfer coils on the basis of the detected result.

A wireless power receiver including a plurality of receiver coils according to an embodiment detects a size of a transfer coil of a wireless power transmitter and selects one receiver coil of the plurality of receiver coils on the basis of the detected result.

### Technical Solution

A wireless power transmitter, which transfers wireless power to a wireless power receiver, according to an embodiment includes: a power supply unit; a transfer coil unit including a plurality of transfer coils, which are connected to each other to form one body and have sizes different from each other; and a control unit configured to detect a size of a receiver coil of the wireless power receiver and determine one transfer coil for transferring the wireless power to the receiver coil among the plurality of transfer coils on the basis of the size of the receiver coil.

A wireless power receiver, which receives wireless power from a wireless power transmitter, according to an embodiment includes: a receiver coil unit including a plurality of receiver coils, which are connected to each other to form one body and have sizes different from each other; and a control unit configured to detect a size of a transfer coil of the wireless power transmitter and determine one receiver coil for receiving the wireless power from the transfer coil among the plurality of receiver coils on the basis of the size of the transfer coil.

A method for operating a wireless power transmitter, which transfers wireless power to a wireless power receiver, according to an embodiment includes: transmitting and receiving identification information to and from the wireless power receiver; identifying the wireless power receiver; transferring the wireless power to the wireless power receiver; and ending the wireless power transfer, wherein the transferring the wireless power includes: detecting a size of a receiver coil of the wireless power receiver; determining one transfer coil of a plurality of transfer coils, which are connected to each other to form one body and have sizes different from each other, on the basis of the size of the receiver coil; and transferring the wireless power to the wireless power transmitter through the one transfer coil.

A wireless power transmitter, which transfers wireless power to a wireless power receiver, according to an embodiment includes: a transfer coil unit including a plurality of transfer coils having sizes different from each other; and a control unit detecting a size of a receiver coil of the wireless power receiver and determining one transfer coil for transferring the wireless power to the receiver coil among the plurality of transfer coils on the basis of the size of the receiver coil.

A wireless power receiver, which receives wireless power from a wireless power transmitter, according to an embodiment includes: a receiver coil unit including a plurality of receiver coils having sizes different from each other; and a control unit configured to detect a size of a transfer coil of the wireless power transmitter and determine one receiver coil for receiving the wireless power from the transfer coil among the plurality of receiver coils on the basis of the size of the transfer coil.

A method for operating a wireless power transmitter, which transfers wireless power to a wireless power receiver, according to an embodiment includes: transmitting and receiving identification information to and from the wireless power receiver; identifying the wireless power receiver; transferring the wireless power to the wireless power receiver; and ending the wireless power transfer, wherein the transferring the wireless power includes: detecting a size of a receiver coil of the wireless power receiver; determining one transfer coil of a plurality of transfer coils on the basis of the size of the receiver coil; and transferring the wireless power to the wireless power transmitter through the one transfer coil.

### Advantageous Effects

The wireless power transmitter including the plurality of transfer coils according to the embodiment may detect the size of the receiver coil of the wireless power receiver and select one transfer coil of the plurality of transfer coils on the basis of the detected result to wirelessly transfer the power, thereby maximizing the wireless power transfer efficiency.

The wireless power receiver including the plurality of receiver coils according to the embodiment may detect the size of the transfer coil of the wireless power transmitter and select one receiver coil of the plurality of receiver coils on the basis of the detected result to wirelessly receive the power, thereby maximizing the wireless power receiving efficiency.

The wireless power transmitter including the plurality of transfer coils according to the embodiment may detect the size of the receiver coil of the wireless power receiver and select one transfer coil of the plurality of transfer coils on the basis of the detected result to wirelessly transfer the power, thereby maximizing the wireless power transfer efficiency.

The wireless power receiver including the plurality of receiver coils according to the embodiment may detect the size of the transfer coil of the wireless power transmitter and select one receiver coil of the plurality of receiver coils on the basis of the detected result to wirelessly receive the power, thereby maximizing the wireless power receiving efficiency.

### BRIEF DESCRIPTION OF THE DRAWINGS

FIG. 1 is an equivalent circuit view of a magnetic induction method.

FIG. 2 is an equivalent circuit view of a magnetic resonance method.

FIG. 3 is a block diagram of a transfer device as one of a sub system constituting a wireless power transfer system according to an embodiment.

FIG. 4 is a block diagram of a transfer device as one of a sub system constituting a wireless power transfer system according to another embodiment.

FIG. 5 is a block diagram of a receiver unit as one of the sub system constituting the wireless power transfer system according to an embodiment.

FIG. 6 is a block diagram of a receiver unit device as one of a sub system constituting a wireless power transfer system according to another embodiment.

FIG. 7 is a flowchart illustrating an operation of a wireless power transfer system, which is an operation flowchart based on an operation state of the wireless power transfer system.

FIG. 8 is a top view of a transfer coil unit or a receiver coil unit according to an embodiment.

FIG. 9 is a top view of a transfer coil unit or a receiver coil unit according to another embodiment.

FIG. 10 is a top view of a transfer coil unit or a receiver coil unit according to further another embodiment.

FIG. 11 is a top view of a transfer coil unit or a receiver coil unit according to further another embodiment.

FIG. 12 is a side view of the transfer coil unit or the receiver coil unit according to embodiment.

FIG. 13 is a side view of the transfer coil unit or the receiver coil unit according to another embodiment.

FIG. 14 is a side view of the transfer coil unit or the receiver coil unit according to further another embodiment.

FIG. 15 is a view of a wireless power transmitter according to an embodiment.

FIG. 16 is a flowchart illustrating an operation of the wireless power transmitter according to an embodiment.

FIG. 17 is a view of a wireless power receiver according to an embodiment.

FIG. 18 is a flowchart illustrating an operation of the wireless power receiver according to an embodiment.

FIG. 19 is top and side views of the transfer coil unit or the receiver coil unit according to embodiment.

FIG. 20 is top and side views of the transfer coil unit or the receiver coil unit according to another embodiment.

FIG. 21 is a top view of a transfer coil unit or a receiver coil unit according to further another embodiment.

FIG. 22 is a top view of the transfer coil unit or the receiver coil unit according to further another embodiment.

FIG. 23 is a top view of a transfer coil unit or a receiver coil unit according to further another embodiment.

FIG. 24 is a side view of the transfer coil unit or the receiver coil unit according to further another embodiment.

FIG. 25 is a side view of the transfer coil unit or the receiver coil unit according to further another embodiment.

FIG. 26 is a side view of the transfer coil unit or the receiver coil unit according to further another embodiment.

FIG. 27 is a view of a wireless power transmitter according to another embodiment.

FIG. 28 is a flowchart illustrating an operation of the wireless power transmitter according to another embodiment.

FIG. 29 is a view of a wireless power receiver according to another embodiment.

FIG. 30 is a flowchart illustrating an operation of the wireless power receiver according to further another embodiment.

### MODE FOR CARRYING OUT THE INVENTION

Hereinafter, a coil device according to an embodiment, a method for manufacturing the coil device, and a wireless power transfer device and a wireless power receiver device including the coil device will be described in detail with reference to the accompanying drawings. The following embodiments are provided as mere examples to sufficiently express the ideas of the present invention to the skilled in the art. The prevent invention may, however, be embodied in different forms and should not be construed as limited to the embodiments set forth herein. Also, in the drawings, the size and thickness of the device may be exaggerated for convenience. Like reference numerals designate like elements throughout the specification.

The embodiments may include a communication system that selectively uses various frequency bands ranging from a lower frequency (50 KHz) to a high frequency (15 MHz) to wirelessly transmit power and is capable of exchanging data and a control signal to control the system.

The embodiments may be applied to various industrial fields such as mobile terminal industries using electronic equipment in which a battery is used or required, smart clock industries, computer and notebook industries, household appliance industries, medical device industries, robot industries, and the like.

The embodiments may consider a system capable of transferring power to one or more plural devices by using one or a plurality of transfer coils.

According to the embodiments, the battery shortage problem in the mobile devices such as smart phones and notebooks may be solved. For example, when a wireless charging pad is placed on a table, and a smart phone or a notebook is used on the table, the battery may be automatically charged and thus be used for a long time. In addition, when the wireless charging pad is installed on public places such as cafeterias, airports, taxis, offices, restaurants, and the like, various mobile devices may be charged regardless of charging terminals which are different from each other according to the manufactures of the mobile devices. Also, when the wireless power transfer technology is applied to the household electrical appliances such as cleaners, electric fans, and the like, there is no need to look for power cables, and complex wires may be disappeared in the home. Therefore, wires within buildings may be reduced, and space utilization may be improved. Also, when electric vehicles are charged by using the current household power, a time taken to charge the electric vehicles may increase. However, if high power is transmitted to the electric vehicles through the wireless power transfer technology, the charging time may be reduced. In addition, when the wireless charging facility is installed on the floor of the parking lot, power cables around the electric vehicles may not be prepared.

The terms and abbreviations used in the embodiments are as follows.

Wireless power transfer system: means a system providing wireless power transfer within a magnetic field area.

Wireless power transfer system-charger; power transfer unit (PTU): called a wireless power transmitter or a transmitter as a device for managing an entire system, which wirelessly transfers power to the wireless power receiver device within magnetic fields.

Wireless power receiver system-device; power receiver unit (PRU): called a wireless power receiver or a receiver as a device for wirelessly receiving power from the wireless power transfer device within magnetic fields.

Charging area: an area in which wireless power transfer is performed within a magnetic field area and which varies depending on a size, required power, and an operation frequency of an application product.

Scattering parameter: S parameter is a ratio (transmission; S1) of an input port to an output port or a self-reflection value of each of the input/output ports, i.e., an output value (reflection; S₁₁ and S₂₂) reflected back from its input in terms of a ratio of an input voltage to an output voltage on a frequency distribution.

Quality factor: a value of Q in resonance means quality of frequency selection. The hinger the Q value, the better the resonance characteristics. The Q value is expressed as a ratio of energy stored in a resonator to lost energy.

Typically, there are a magnetic induction method and a magnetic resonance method as a method for wirelessly transferring power.

The magnetic induction method is a noncontact energy transfer technique in which electromotive force is generated in a load inductor L_{f} by using a magnetic flux, which is generated when source inductors Lₛ are close to each other, and current is supplied to one of the source inductors Lₛ, as a medium. Also, the magnetic resonance method combines two resonators to generate magnetic resonance by a natural frequency between the two resonators and wirelessly transmits energy by using a resonance technique in which the resonators vibrate at the same frequency to form electric fields and magnetic fields in the same wavelength range.

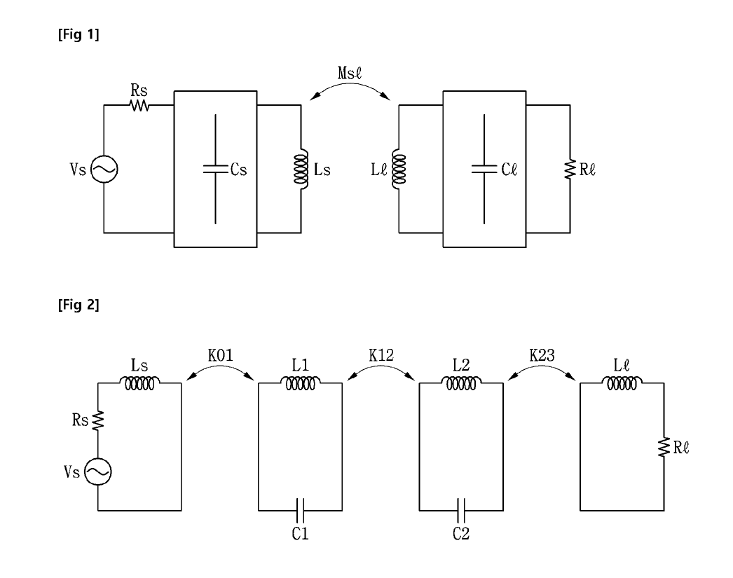

FIG. 1 is an equivalent circuit view of a magnetic induction method.

Referring to FIG. 1, in the magnetic induction type equivalent circuit, a transfer device may include a source voltage Vₛ, a source resistor Rs, a source capacitor Cₛ for impedance matching, and a source coil Lₛ for magnetic coupling with a receiver unit according to devices for supplying power. The receiver unit may include a load resistor Rₗ that is an equivalent load of the receiver unit, a load capacitor Cₗ for impedance matching, and a load coil Lₗ for magnetic coupling with the transfer device. A degree of the magnetic coupling of the source coil Lₛ and the load coil Lₗ may be represented by a mutual inductance Mₛₗ.

In FIG. 1, a ratio S₂₁ of the input voltage to the output voltage is obtained from the magnetic induction equivalent circuit constituted by only the coil without the source capacitor Cₛ and the load capacitor Cₗ for the impedance matching. As a result, when a maximum power transfer condition is found from the ratio S₂₁, the maximum power transfer condition satisfies the following Expression 1.

Lₛ/Rₛ=Lₗ/Rₗ [Equation 1]

The maximum power transfer is possible when the ratio of the inductance of the transfer coil Lₛ to the source resistor Rₛ and the ratio of the inductance of the load coil Lₗ to the load resistor Rₗ are the same. In a system with only an inductance, since there is no capacitor capable of compensating for reactance, a value of the self-reflection value S₁₁ of each of the input/output ports may not be zero at a point at which the maximum power transfer occurs. Also, power transfer efficiency may significantly vary depending on the value of the mutual inductance Mₛₗ. Thus, the source capacitor Cₛ may be added to the transfer device as a compensation capacitor for the impedance matching. In addition, the load capacitor Cₗ may be applied to the receiver unit. The compensation capacitors Cₛ and Cₗ may be, for example, connected to the receiver coil Lₛ and the load coil Lₗ in series or parallel to each other, respectively. Also, an additional capacitor and a passive element such as an inductor may be further added to the transfer device and the receiver unit for the impedance matching, respectively.

FIG. 2 is an equivalent circuit view of the magnetic resonance method.

Referring to FIG. 2, in the magnetic resonance type equivalent circuit, the receiver device may include a source coil constituting a closed circuit by connecting a source voltage Vₛ, a source resistor Rₛ, and a source inductor Lₛ to each other in series and a transfer-side resonant coil constituting a closed circuit by connecting a transfer-side resonant inductor L1 to a transfer-side resonant capacitor Cₗ in series. The receiver unit may include a load coil constituting a closed circuit by connecting a load resistor Rₗ to a load inductor Lₗ in series and a receiver-side resonant coil constituting a closed circuit by connecting a receiver-side resonant inductor L₂ to a receiver-side resonant capacitor C₂ in series. The source inductor Lₛ and the transfer-side inductor L1 may be magnetically coupled to each other with a coupling coefficient of K₀₁. The load inductor Lₗ and the load-side resonant inductor L₂ may be magnetically coupled to each other with a coupling coefficient of K₂₃. The transfer-side resonant inductor L1 and the receiver-side resonant inductor L₂ may be magnetically coupled to each other with a coupling coefficient of K₁₂. In the equivalent circuit according to further another embodiment, the source coil and/or the load coil may be omitted, and only the transfer-side resonant coil and the receiver-side resonant coil may be provided.

When the two resonators have the same resonance frequency, most of energy of the resonator of the transfer device may be transferred to the receiver unit to improve transfer efficiency. The efficiency of the magnetic resonance method may be improved when the following Equation 2 is satisfied.

K/Γ>>1 [Equation 2]

(where, k is a coupling coefficient, and Γ is an attenuation factor)

To improve the efficiency in the magnetic resonance method, the element for the impedance matching may be added. Also, the impedance matching element may be a passive element such as the inductor and the capacitor.

As described above, a wireless power transfer system for transferring power in the magnetic induction or magnetic resonance method based on the principle of the wireless power transfer will be described.

FIG. 3 is a block diagram of the transfer device as one of a sub system constituting the wireless power transfer system according to an embodiment.

The wireless power transfer device 310 according to an embodiment may be called a wireless power transmitter, a transmitter, or a transfer device.

The wireless power transfer system according to an embodiment may include a transfer device 310 and a receiver device 320 wirelessly receiving power from the transfer device 310. The wireless power transfer device 310 may include a transfer-side power conversion unit 311 that converts an inputted AC signal into power to output the power into an AC signal. The wireless power transfer device 310 may include a transfer-side resonant circuit unit 312 that generates magnetic fields on the basis of the AC signal outputted from the transfer-side power conversion unit 311 to provide power to the wireless power receiver device 320 within the charging area. The wireless power transfer device 310 may include a transfer-side control unit 303 controlling the power conversion of the transfer-side power conversion unit 311. The transfer-side control unit 303 may adjust an amplitude and frequency of the output signal of the transfer-side power conversion unit 311. The transfer-side control unit 303 may perform impedance matching of the transfer-side resonant circuit unit 102. The transfer-side control unit 303 may sense an impedance, a voltage, and current information from the transfer-side power conversion unit 311 and the transfer-side resonant circuit unit 312. The transfer-side control unit 303 may wirelessly communicate with the receiver device 320.

The transfer-side power conversion unit 311 may include at least one of a power conversion part (not shown) that converts an AC signal into a DC, a power conversion part (not shown) that outputs a DC by changing a level of the DC, and a power conversion part (not shown) that converts DC into AC. Also, the transfer-side resonant circuit unit 312 may include a coil and an impedance matching part (not shown) that resonant with the coil. Also, the transfer-side control unit 313 may include a sensing part (not shown) for sensing an impedance, a voltage, and current information and a wireless communication part (not shown).

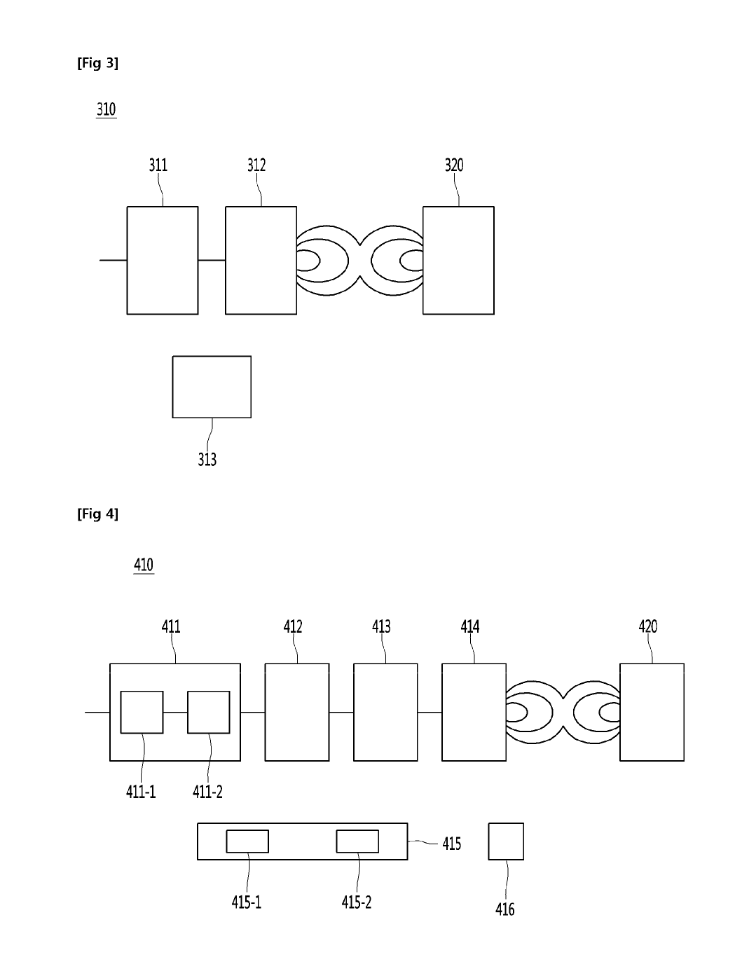

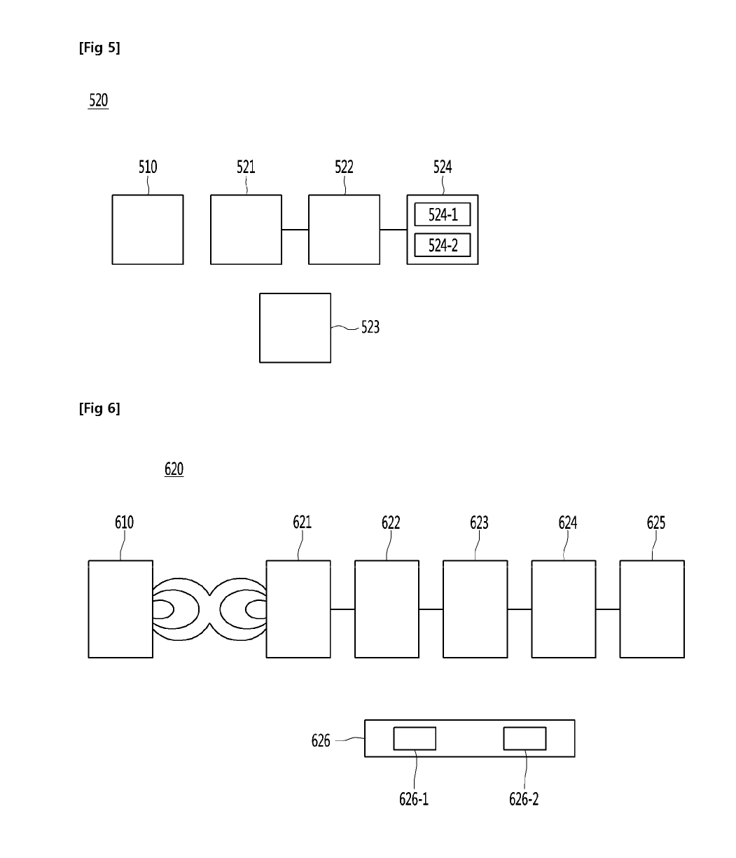

FIG. 4 is a block diagram of a transfer device as one of a sub system constituting a wireless power transfer system according to another embodiment.

Referring to FIG. 4, a transfer device 410 may include a transfer-side AC/DC conversion unit 411, a transfer-side DC/AC inversion unit 412, a transfer-side impedance matching unit 413, a transfer coil unit 414, and a transfer-side communication and control unit 415.

The transfer-side AC/DC conversion unit 411 may be a power conversion unit that converts an AC signal provided from the outside into a DC signal under the control of the transfer-side communication and control unit 415. The transfer-side AC/DC conversion unit 311 may include a rectifier 411-1 as a sub system and a transfer-side DC/DC conversion part 411-2. The rectifier 411-1 is a system that converts the provided AC signal into a DC signal. The rectifier 411-1 may be a diode rectifier having relatively high efficiency during a high-frequency operation. The rectifier 411-1 may be a one-chip synchronous rectifier. The rectifier 411-1 may be a hybrid rectifier capable of saving costs and a space and having a high degree of freedom in a dead time. However, this embodiment is not limited thereto. For example, the rectifier 411-1 may be variously applied so long as the rectifier 411-1 is a system that converts AC into DC. Also, the transfer-side DC/AC conversion part 411-2 may adjust a level of the DC signal provided from the rectifier 411-1 under the control of the transfer-side communication and control unit 415. The transfer-side DC/AC conversion part 411-2 may be a buck converter that reduces a level of the input signal. The transfer-side DC/AC conversion part 411-2 may be a boost converter increasing the level of the input signal. The transfer-side DC/AC conversion part 411-2 may be a buck boost converter or a cuk converter that decreases or increases the level of the input signal/The transfer-side DC/AC conversion part 411-2 may include a switching element performing a power conversion control function. The transfer-side DC/AC conversion part 411-2 may include an inductor and a capacitor that serve as a power conversion medium or perform an output voltage smoothing function. The transfer-side DC/AC conversion part 411-2 may include a transformer for adjusting a voltage gain or performing an electrical separation function (insulation function). The transfer-side DC/AC conversion part 411-2 may remove a ripple component included in the inputted DC signal or a pulsation component (an AC component included in the DC signal) included in the ripple component. The transfer-side communication and control unit 415 may adjust an error between a command value of the output signal of the transfer-side DC/DC conversion part 411-2 and an actual output value through a feedback method.

The transfer-side DC/AC inversion unit 412 may invert a DC signal outputted from the transfer-side AC/DC conversion unit 411 into an AC signal under the control of the transfer-side communication and control unit 415 and adjust the inverted AC signal. The transfer-side DC/AC inversion unit 412 may be a half bridge inverter or a full bridge inverter. Also, in the wireless power transfer system, various amplifiers that convert DC into AC may be applied. For example, A-class, B-class, C-class, E-class, and F-class amplifiers may be applied. Also, the transfer-side DC/AC inversion unit 412 may include an oscillator (not shown) for generating a frequency of the output signal and a power amplifier (not shown) for amplifying the output signal.

The constituents of the AC/DC conversion unit and the DC/AC inversion unit 412 may be replaced with an AC power supply or may be omitted or replaced with another constituent.

The transfer-side impedance matching unit 413 may minimize reflected waves at points having different impedances so that a signal smoothly flows. Since the transfer device 410 and the receiver device 420 may be spatially separated from each other to cause leakage of a large amount of magnetic fields, a difference in impedance between two connection terminals of the transfer device 410 and the receiver device 420 may be corrected to improve power transfer efficiency. The transfer-side impedance matching unit 413 may be constituted by at least one of an inductor, a capacitor, and a resistance element. The transfer-side matching unit 413 may allow an impedance of the inductor, a capacitance of the capacitor, and a resistance value of the resistor to vary and thereby to adjust the impedance value for the impedance matching. Also, when the wireless power transfer system transfers power in the magnetic induction method, the transfer-side impedance matching unit 413 may have a series resonance structure or a parallel resonance structure. The transfer-side impedance matching unit 413 may increase an induction coupling coefficient between the transfer device 410 and the receiver device 420 to minimize energy loss. Also, when the wireless transfer system transfers power in the magnetic resonance method, the transfer-side impedance matching unit 413 may vary in a distance spaced between the transfer device 410 and the receiver device 420 or vary in characteristic of the coil due to metallic foreign object (FO) and an interaction by the plurality of devices to correct the impedance matching in real time according to a variation in matching impedance on an energy transfer line. Here, the correction method may include a multi matching method using the capacitor, a matching method using a multi antenna, and a method using a multi loop.

The transfer-side coil 414 may be provided as a plurality of coils or a single coil. When the transfer-side coil 414 is provided in plurality, the plurality of transfer-side coils may be spaced apart from each other or overlap each other. When the plurality of transfer-side coils 414 overlap each other, an overlapping area may be determined in consideration of a deviation in magnetic flux density. Also, when the transfer-side coil 414 is manufactured, the transfer-side coil 414 may be manufactured in consideration of internal resistance and radiation resistance. Here, if the resistance component of the transfer-side coil 414 is low, a quality factor may increase, and transfer efficiency may be improved.

The communication and control unit 415 may include a transfer-side control part 415-1 and a transfer-side communication part 415-2. The transfer-side control part may adjust an output voltage (or current lₜₓ_{_}_{coil} flowing through the transfer coil) of the transfer-side AC/DC conversion unit 411 in consideration of at least one or more of power requirement of the wireless power receiver device 420, current charging power, a voltage V_{rect} at a rectifier output terminal of the receiver device 420, charging efficiency of each of the receiver units, and the wireless power method. Also, a frequency for driving the transfer-side DC/AC inversion unit 412 and power to be transferred by generating switching waveforms may be controlled in consideration of the maximum power transfer efficiency. Also, the overall operation of the receiver device 420 may be controlled by using algorithm, program, or application required for the control of read from a storage unit (not shown) of the receiver device. The transfer-side control part 415-1 may be called a microprocessor, a micro controller unit (MCU), or a micom. The transfer-side communication part 415-2 may perform communication with the receiver-side communication part. The transfer-side communication part 415-2 may use a short distance communication method such as Bluetooth, NFC, Zigbee, and the like. The transfer-side communication part 415-2 and the receiver-side communication part may transmit and receive charging status information and a charging control command to each other. Also, the charging status information may include the number of wireless power receiver device 420, a battery remaining amount, the number of times of charging, an amount of usage, a battery capacity, a battery ratio, and transfer power of the transfer device 410. Also, the transfer-side communication part 415-2 may transmit a charging function control signal for controlling a charging function of the receiver device 420. The charging function control signal may be a control signal that controls the wireless power receiver device 420 to enable to disable the charging function.

As described above, the transfer-side communication part 415-2 may communicate in an out-of-band type, which is constituted by a separate module, but is not limited thereto. The transfer-side communication part 415-2 may use a feedback signal that is transmitted from the receiver device 420 to the transfer device 1000 by using a power signal transmitted by the transfer device 410. The transfer-side communication part 415-2 may perform communication in an in-band type in which the transfer device 410 transmits a signal to the receiver device 420 by using a frequency shift of the power signal transmitted by the transfer device 410. For example, the receiver device 420 may modulate the feedback signal and transmit information such as charging start, charging end, a battery state, and the like to the wireless power transfer device 410 through the feedback signal. The transfer-side communication part 415-2 may be provided as a separate part with respect to the transfer-side control part 415-1. Also, the wireless power transfer device 410 of the wireless power transfer system according to an embodiment may additionally include a detection unit 416.

The detection unit 416 may detect at least one of an input signal of the transfer-side AC/DC conversion unit 411, an output signal of the transfer-side AC/DC conversion unit 411, an input signal of the transfer-side DC/AC inversion unit 412, an output signal of the transfer-side DC/AC inversion unit 412, an input signal of the transfer-side impedance matching unit 413, an output signal of the transfer-side impedance matching unit 413, an input signal of the transfer-side coil 414, and a signal on the transfer-side coil 414. For example, the signal may include at least one of information on current, information on a voltage, and information on an impedance. The detected signal may be feedback to the communication and control unit 415, and the communication and control unit 415 may control the transfer-side AC/DC conversion unit 411, the transfer-side DC/AC inversion unit 412, and the transfer-side impedance matching unit 413 on the basis of the feedback signal. In addition, the communication and control unit 415 may perform foreign object detection (FOD) on the basis of the detection result. The detected signal may be at least one of a voltage and current. The detection unit 416 may be implemented by hardware different from the communication and control unit 415 or one hardware.

FIG. 5 is a block diagram of the receiver unit as one of the sub system constituting the wireless power transfer system according to an embodiment.

According to an embodiment, the wireless power transfer device 520 may be called a wireless power receiver, a receiver device, or a receiver.

Referring to FIG. 5, the wireless power transfer system according to an embodiment may include a transfer device 510 and a receiver device 520 wirelessly receiving power from the transfer device 510. The receiver device 520 may include a receiver-side resonant circuit unit 521, a receiver-side power conversion unit 522, a receiver-side control unit 523, and a load 524.

The receiver-side resonant circuit unit 521 may receive an AC signal transmitted from the transfer device 510. The receiver-side conversion unit 522 may convert the AC power from the receiver-side resonant circuit unit 521 to output a DC signal.

The load 524 may receive the DC signal outputted from the receiver-side conversion unit 202 and then be charged. The load 524 may include a battery 524-1 and a battery management part 524-1. The battery management part 524-1 may detect a charged state of the battery 524-1 to adjust a voltage and current applied to the battery 524-1.

The receiver-side control unit 523 may sense a current voltage of the receiver-side resonant circuit unit 521. The receiver-side control unit 523 may perform impedance matching of the receiver-side resonant circuit unit 521. The receiver-side control unit 523 may control power conversion of the receiver-side power conversion unit 522. The receiver-side control unit 523 may adjust a level of the output signal of the receiver-side power conversion unit 522. The receiver-side control unit 523 may sense an input or output voltage or current of the receiver-side power conversion unit 522. The receiver-side control unit 523 may control whether the output signal of the receiver-side power conversion unit 522 is supplied to the load 524. The receiver-side control unit 523 may communicate with the transfer device 510.

Also, the receiver-side power conversion unit 522 may include a power conversion part that converts an AC signal into DC, a power conversion part that outputs the DC by changing a level of the DC, and a power conversion part that converts DC into AC.

FIG. 6 is a block diagram of a receiver unit device as one of a sub system constituting a wireless power transfer system according to another embodiment.

Referring to FIG. 6, the wireless power transfer system according to an embodiment may include a transfer device 510 and a receiver device 620 wirelessly receiving power from the transfer device 510. The receiver device 620 may include a receiver-side coil unit 621, a receiver-side impedance matching unit 622, a receiver-side AC/DC conversion unit 623, a DC/DC conversion unit 624, a load 625, and a receiver-side communication and control unit 626. The receiver-side AC/DC conversion unit 623 may be called a rectifying part that rectifies the AC signal into the DC signal.

The receiver-side coil unit 621 may receive power through the magnetic induction method or the magnetic resonance method. As described above, at least one of an induction coil or a resonant coil may be provided according to the power receiving method.

For example, the receiver-side coil unit 621 may be disposed on a portable terminal together with an antenna for near field communication (NFC). Also, the receiver-side coil unit 621 may be the same as the transfer-side coil unit. A dimension of the receiver antenna of the receiver-side coil unit 621 may vary in electrical characteristic of the receiver device 620.

The receiver-side impedance matching unit 622 may perform impedance matching between the transfer device 610 and the receiver device 620.

The receiver-side AC/DC conversion unit 623 rectifies the AC signal outputted from the receiver-side coil unit 621 to generate the DC signal. Also, the output voltage of the receiver-side AC/DC conversion unit 623 may be called a rectified voltage V_{rect}, and the receiver-side communication and control unit 626 may detect or change the output voltage of the receiver-side AC/DC conversion unit 623. The receiver-side communication and control unit 626 may transmit status parameter information such as information on a minimum rectified voltage V_{rect}_{_}ₘᵢₙ (or called a minimum output voltage) that is a minimum value of the output voltage of the receiver-side AC/DC conversion unit 623, a maximum rectified voltage V_{rect}_{_}ₘₐₓ (or called a maximum output voltage) that is a maximum value, and an optimum rectified voltage V_{rect}_{_}ₛₑₜ (or called an optimum output voltage) having any one voltage value of the maximum value and the minimum value.

The receiver-side DC/DC conversion unit 624 may adjust a level of the DC signal outputted from the receiver-side AC/DC conversion unit 623 to match a capacity of the load 625. The load 625 may include a battery, a display, a sound output circuit, a main processor, a battery management unit, and various sensors.

The receiver-side communication and control unit 626 may be activated by wake-up power received from the transfer-side communication and control unit. The receiver-side communication and control unit 626 may perform communication with the transfer-side communication and control unit. The receiver-side communication and control unit 626 may control an operation of the sub system of the receiver device 620.

The receiver device 620 may be provided in a single or plurality to wirelessly receive energy from the transfer device 610 at the same time. That is, in the wireless power transfer system using the magnetic resonance method, a plurality of receiver devices may receive power from one transfer device 610. Here, the transfer-side impedance matching unit of the transfer device 610 may adaptively perform impedance matching between the plurality of receiver devices. This may be equally applied a case in which the receiver-side coil units that are independent of each other in the magnetic induction method are provided in plurality.

Also, when the receiver device 620 is provided in plurality, the receiver devices may be systems in which the power receiving methods are the same or different from each other. In this case, the transfer device 610 may be a system for transferring power in the magnetic induction method or the magnetic resonance method or a system in which both the methods are mixed.

Referring to a relationship between the size of a signal and a frequency of the wireless power transfer system, in the case of the wireless power transfer using the magnetic induction method, the transfer-side AC/DC conversion unit in the transfer device 610 may receive an AC signal having several ten voltages to several hundred voltages (for example, 110 V to 220 V) or a frequency of several ten Hz or several hundred Hz (for example, 60 Hz) to convert the received AC signal into a DC signal, thereby outputting the DC signal. The transfer-side DC/AC conversion unit may receive the DC signal to output the AC signal having a frequency of KHz band (for example, 125 KHz). Also, the receiver-side AC/DC conversion unit 623 of the receiver device 620 may receive an AC signal having a frequency of KHz band (for example, 125 KHz) to convert the received AC signal into a DC signal having several voltages to several ten voltages or several hundred voltages, thereby outputting the converted DC signal. The receiver-side DC/DC conversion unit 624 may output a voltage that is adequate for the load 625, for example, a DC signal having a voltage of 5 V to transmit the outputted voltage to the load 625. Also, in the case of the wireless power transfer using the magnetic resonance method, the transfer-side AC/DC conversion unit in the transfer device 610 may receive an AC signal having several ten voltages to several hundred voltages (for example, 110 V to 220 V) or a frequency of several ten Hz or several hundred Hz (for example, 60 Hz) to convert the received AC signal into a DC signal having several voltages to several hundred voltages (for example, 10 V to 20 V), thereby outputting the DC signal. The transfer-side DC/AC conversion unit may receive the DC signal to output the AC signal having a frequency of KHz band (for example, 6.78 MHz). Also, the receiver-side AC/DC conversion unit 623 of the receiver device 620 may receive an AC signal having a frequency of KHz (for example, 6.78 MHz) to convert the received AC signal into a receiver-side DC signal having several voltages to several ten voltages or several hundred voltages (for example, 10 V to 20 V), thereby outputting the converted DC signal. The DC/DC conversion unit 624 may output a voltage that is adequate for the load 625, for example, a DC signal having a voltage of 5 V to transmit the outputted voltage to the load 625.

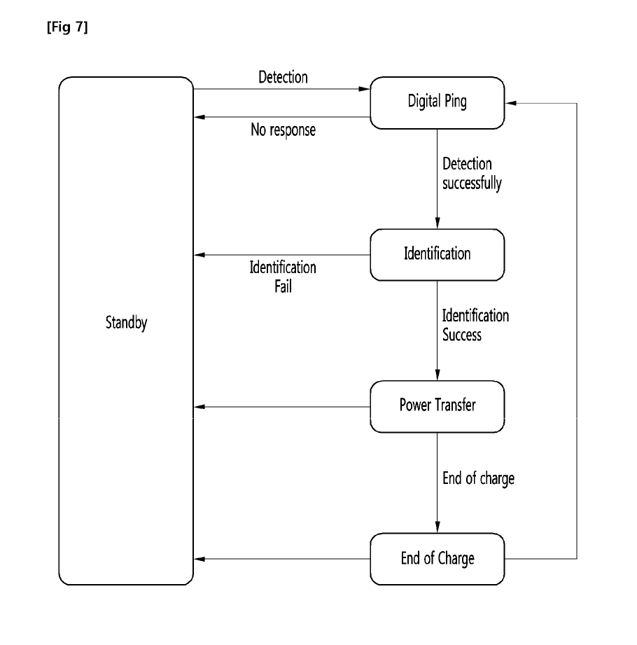

FIG. 7 is a flowchart illustrating an operation of the wireless power transfer system, which is an operation flowchart based on an operation state of the wireless power transfer system.

Referring to FIG. 7, the transfer unit according to an embodiment may have 1) a standby state, 2) a digital ping state, 3) an identification state, 4) a power transfer state, and 5) an end state of charge.

[Standby State]

(1) When power is applied to the transfer unit from the outside to drive the transfer unit, the transfer unit may become a standby state. The transfer unit that is in the standby state may detect whether an object disposed on the charging area (for example, the receiver unit or metallic foreign object (FO) exist.

(2) A method for detecting the presence of the object on the charging area may detect the object by monitoring a variation in magnetic flux, a variation in capacitance or inductance between the object and a transfer unit, or a shift in resonance frequency, but is not limited thereto.

(3) When the transfer unit detects the object that is the receiver unit within the charging area, the standby state may proceed to the digital ping state that is the next process.

[Digital Ping State]

(1) In the digital ping state, the transfer unit is connected to a chargeable receiver unit and confirms whether the receiver unit is in a state of an effective receiver unit that is chargeable with wireless power provided from the transfer unit. Also, the transfer unit may generate and output a digital ping having a predetermined frequency and timing so as to be connected to the chargeable receiver unit.

(2) If a sufficient power signal for the digital ping is transmitted to the receiver unit, the receiver unit may respond to the digital ping by modulating the power signal according to a communication protocol. Also, If the transfer unit receives an effective signal from the receiver unit, the digital ping state may proceed to an identification state without removing the power signal. Also, if request of an end of charging (EOC) is received from the receiver unit, the transfer unit may proceed to the end state of charge.

(3) In addition, when the effective receiver unit is not detected, or when the response time of the object for the digital ping exceeds a preset time, the transfer unit may return to the standby state by removing the power signal.

[Identification State]

(1) When the response of the receiver unit according to the digital ping of the transfer unit is completed, the transfer unit may transmit identification information of the transfer unit to the receiver unit to confirm compatibility between the transfer unit and the receiver. Also, when the compatibility is confirmed, the receiver unit may transmit the identification information to the transfer unit. Also, the transfer unit may confirm the identification information of the receiver unit.

(2) When the mutual identification of the transfer unit is completed, the identification state may proceed to a power transfer state. If the identification state fails, or the identification time exceeds a predetermined identification time, the identification state may return to the standby state.

[Power Transfer State]

(1) The communication and control unit of the transfer unit may control the transfer unit on the basis of control data received from the receiver unit to provide charging power to the receiver unit.

(2) Furthermore, the transfer unit may verify whether the charging power is out of an appropriate operation range, or stability against the foreign object detection (FOD) is a problem.

(3) Also, when the transfer unit receives the charge end signal from the receiver unit, or the operation range exceeds a predetermined limit temperature value, the transfer unit may stop the power transfer to proceed to the end state of charge.

(4) Also, in the case of a situation where the power is not suitable for the transfer, the transfer unit may remove the power signal and return to the standby state. Also, if the transfer unit enters the charging area again after the receiver unit is removed, the above-described cycle may proceed again.

(5) Also, the transfer unit may return to the identification state again according to the charging state of the load of the receiver unit and provide the adjusted charging power to the receiver unit on the basis of the status information of the load.

[End State of Charge: EOC]

(1) When the transfer unit receives the information in which the charging is completed from the receiver unit or he receiver unit receives the information in which a temperature is risen above a preset temperature, the power transfer state may proceed to an end state of change.

(2) When the transfer unit receives the charge completion information from the receiver unit, the transfer unit may stop the power transfer and standby for a predetermined time. Also, the transfer unit may enter the digital ping state so as to be connected to the receiver unit located in the charging area after the predetermined time has elapsed.

(3) Also, the transfer unit may standby for the predetermined time when receiving information indicating that the preset temperature is exceeded from the receiver unit. Also, the transfer unit may enter the digital ping state so as to be connected to the receiver unit located in the charging area after the predetermined time has elapsed.

(4) Also, the transfer unit may monitor whether the receiver unit is removed from the charging area for a predetermined time. The transfer unit may return to the standby state when the receiver unit is removed from the charging area.

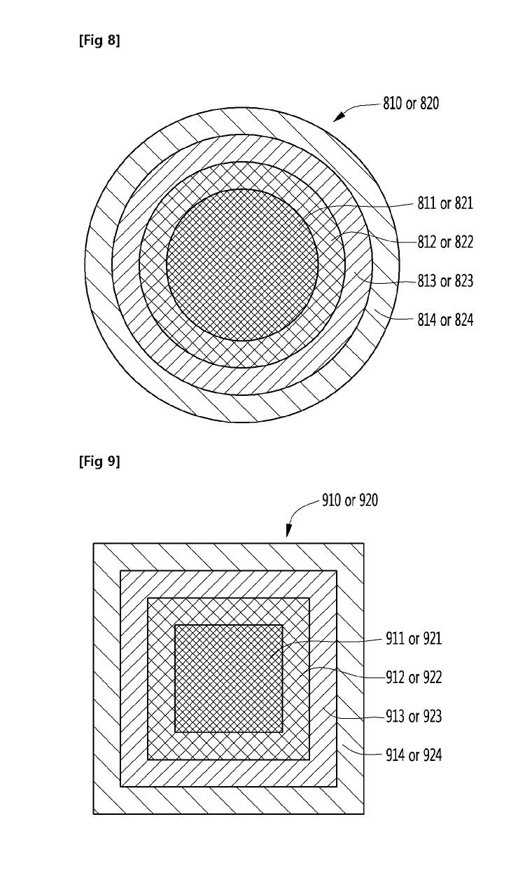

FIG. 8 is a top view of a transfer coil unit or a receiver coil unit according to an embodiment.

Referring to FIG. 8, a transfer coil unit 810 according to an embodiment may include a plurality of transfer coils 811 to 814. Each of the plurality of transfer coils 811 to 814 may have a circular shape. For example, a first transfer coil 811 may be disposed at a center of the transfer coil unit 810. The transfer coil unit 810 may include a second transfer coil 812 surrounding the first transfer coil 811. The transfer coil unit 810 may include a third transfer coil 813 surrounding the second transfer coil 812. The transfer coil unit 810 may include a fourth transfer coil 814 surrounding the third transfer coil 813. The plurality of transfer coils 811 to 814 may be electrically connected to each other.

According to another embodiment, the transfer coil unit 810 may include a switch for controlling the electrical connection at each of connection portions of the plurality of transfer coils 811 to 814.

The receiver coil unit 820 according to an embodiment may include a plurality of receiver coils 821 to 824. For example, a first receiver coil 821 may be disposed at a center of the receiver coil unit 820. The receiver coil unit 820 may include a second receiver coil 822 surrounding the first receiver coil 821. The receiver coil unit 820 may include a third receiver coil 823 surrounding the second receiver coil 822. The receiver coil unit 820 may include a fourth receiver coil 824 surrounding the third receiver coil 823. The plurality of receiver coils 821 to 824 may be electrically connected to each other.

According to another embodiment, the receiver coil unit 820 may include a switch for controlling the electrical connection at each of connection portions of the plurality of receiver coils 821 to 824.

FIG. 9 is a top view of a transfer coil unit or a receiver coil unit according to another embodiment.

Referring to FIG. 9, a transfer coil unit 910 according to an embodiment may include a plurality of transfer coils 911 to 914. Each of the plurality of transfer coils 911 to 914 may have a circular shape. For example, a first transfer coil 911 may be disposed at a center of the transfer coil unit 910. The transfer coil unit 910 may include a second transfer coil 912 surrounding the first transfer coil 911. The transfer coil unit 910 may include a third transfer coil 913 surrounding the second transfer coil 912. The transfer coil unit 910 may include a fourth transfer coil 914 surrounding the third transfer coil 913. The plurality of transfer coils 911 to 914 may be electrically connected to each other.

According to another embodiment, the transfer coil unit 910 may include a switch for controlling the electrical connection at each of connection portions of the plurality of transfer coils 911 to 914.

The receiver coil unit 920 according to an embodiment may include a plurality of receiver coils 921 to 924. For example, a first receiver coil 921 may be disposed at a center of the receiver coil unit 920. The receiver coil unit 920 may include a second receiver coil 922 surrounding the first receiver coil 921. The receiver coil unit 920 may include a third receiver coil 923 surrounding the second receiver coil 922. The receiver coil unit 920 may include a fourth receiver coil 924 surrounding the third receiver coil 923. The plurality of receiver coils 921 to 924 may be electrically connected to each other.

According to another embodiment, the receiver coil unit 920 may include a switch for controlling the electrical connection at each of connection portions of the plurality of receiver coils 921 to 924. According to an embodiment, each of the plurality of transfer coils 911 to 914 may have a square shape. The, each of the plurality of receiver coils 921 to 924 may have a square shape.

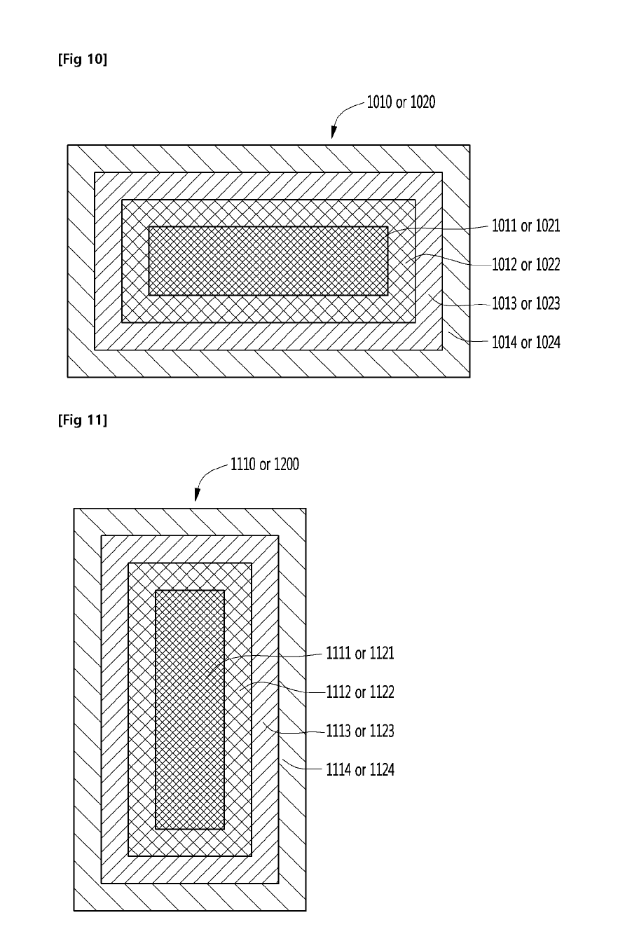

FIG. 10 is a top view of a transfer coil unit or a receiver coil unit according to further another embodiment.

Referring to FIG. 10, a transfer coil unit 1010 according to an embodiment may include a plurality of transfer coils 1011 to 1014. Each of the plurality of transfer coils 1011 to 1014 may have a circular shape. For example, a first transfer coil 1011 may be disposed at a center of the transfer coil unit 1010. The transfer coil unit 1010 may include a second transfer coil 1012 surrounding the first transfer coil 1011. The transfer coil unit 1010 may include a third transfer coil 1013 surrounding the second transfer coil 1012. The transfer coil unit 1010 may include a fourth transfer coil 1014 surrounding the third transfer coil 1013. The plurality of transfer coils 1011 to 1014 may be electrically connected to each other.

According to another embodiment, the transfer coil unit 1010 may include a switch for controlling the electrical connection at each of connection portions of the plurality of transfer coils 1011 to 1014.

The receiver coil unit 1020 according to an embodiment may include a plurality of receiver coils 1021 to 1024. For example, a first receiver coil 1021 may be disposed at a center of the receiver coil unit 1020. The receiver coil unit 1020 may include a second receiver coil 1022 surrounding the first receiver coil 1021. The receiver coil unit 1020 may include a third receiver coil 1023 surrounding the second receiver coil 1022. The receiver coil unit 1020 may include a fourth receiver coil 1024 surrounding the third receiver coil 1023. The plurality of receiver coils 1021 to 1024 may be electrically connected to each other.

According to another embodiment, the receiver coil unit 1020 may include a switch for controlling the electrical connection at each of connection portions of the plurality of receiver coils 1021 to 1024. According to an embodiment, each of the plurality of transfer coils 1011 to 1014 may have a rectangular shape that extends in a transverse direction. Also, each of the plurality of receiver coils 1021 to 1024 may have a rectangular shape that extends in a transverse direction.

FIG. 11 is a top view of a transfer coil unit or a receiver coil unit according to further another embodiment.

Referring to FIG. 11, a transfer coil unit 1110 according to an embodiment may include a plurality of transfer coils 1111 to 1114. Each of the plurality of transfer coils 1111 to 1114 may have a circular shape. For example, a first transfer coil 1111 may be disposed at a center of the transfer coil unit 1110. The transfer coil unit 1110 may include a second transfer coil 1112 surrounding the first transfer coil 1111. The transfer coil unit 1110 may include a third transfer coil 1113 surrounding the second transfer coil 1112. The transfer coil unit 1110 may include a fourth transfer coil 1114 surrounding the third transfer coil 1113. The plurality of transfer coils 1111 to 1114 may be electrically connected to each other.

According to another embodiment, the transfer coil unit 1110 may include a switch for controlling the electrical connection at each of connection portions of the plurality of transfer coils 1111 to 1114.

The receiver coil unit 1120 according to an embodiment may include a plurality of receiver coils 1121 to 1124. For example, a first receiver coil 1121 may be disposed at a center of the receiver coil unit 1120. The receiver coil unit 1120 may include a second receiver coil 1122 surrounding the first receiver coil 1121. The receiver coil unit 1120 may include a third receiver coil 1123 surrounding the second receiver coil 1122. The receiver coil unit 1120 may include a fourth receiver coil 1124 surrounding the third receiver coil 1123. The plurality of receiver coils 1121 to 1124 may be electrically connected to each other.

According to another embodiment, the receiver coil unit 1120 may include a switch for controlling the electrical connection at each of connection portions of the plurality of receiver coils 1121 to 1124. According to an embodiment, each of the plurality of transfer coils 1111 to 1114 may have a rectangular shape that extends in a longitudinal direction. Also, each of the plurality of receiver coils 1121 to 1124 may have a rectangular shape that extends in a longitudinal direction.

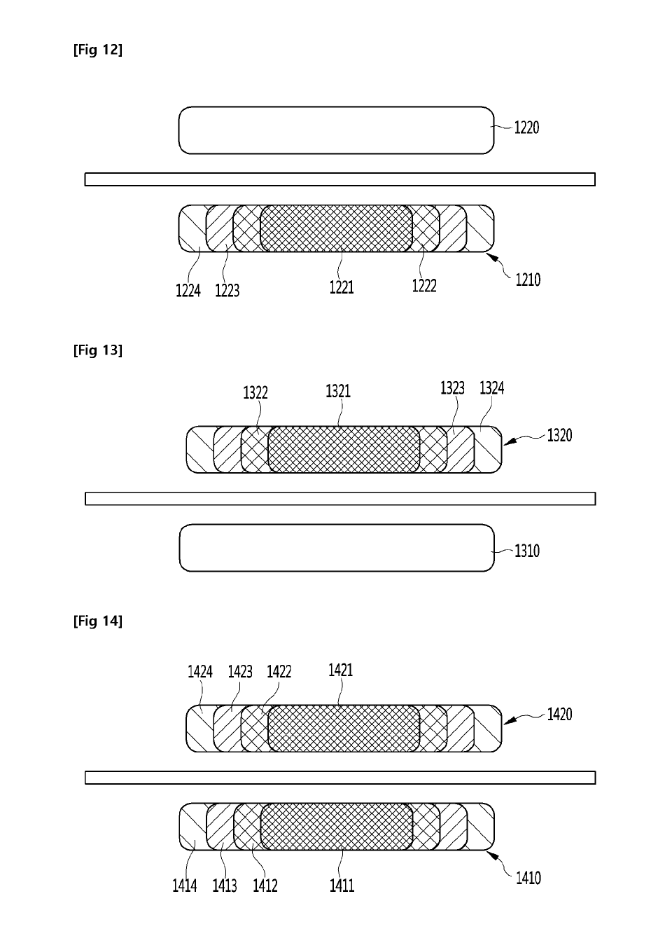

FIG. 12 is a side view of the transfer coil unit or the receiver coil unit according to embodiment.

Referring to FIG. 12, the plurality of transfer coils 1211 to 1214 of the transfer coil unit 1210 may be disposed on the same plane in a horizontal direction. Here, the receiver coil unit 1220 may be provided as one receiver coil.

FIG. 13 is a side view of the transfer coil unit or the receiver coil unit according to another embodiment.

Referring to FIG. 13, the plurality of receiver coils 1321 to 1324 of the receiver coil unit 1320 may be disposed on the same plane in a horizontal direction. Here, the transfer coil unit 1310 may be provided as one receiver coil.

FIG. 14 is a side view of the transfer coil unit or the receiver coil unit according to further another embodiment.

Referring to FIG. 14, the plurality of transfer coils 1411 to 1414 of the transfer coil unit 1410 may be disposed on the same plane in a horizontal direction. Also, the plurality of receiver coils 1421 to 1424 of the receiver coil unit 1420 may be disposed on the same plane in a horizontal direction.

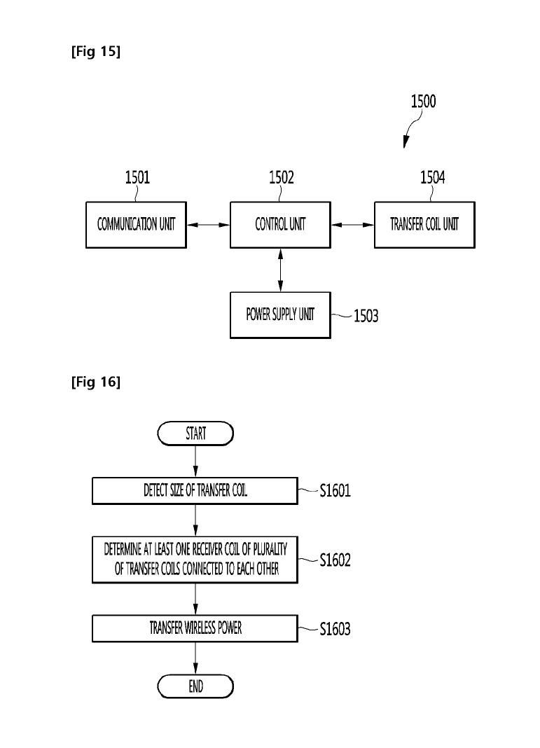

FIG. 15 is a view of a wireless power transmitter according to an embodiment.

Referring to FIG. 15, a wireless power transmitter 1500 may include a communication unit 1501, a control unit 1502, a power supply unit 1503, and a transfer coil unit 1504.

The transfer coil unit 1504 may include a plurality of transfer coils, which are connected to each other to form one body and have sizes different from each other. The control unit 1502 may detect a size of a receiver coil of a wireless power receiver. The control unit 1502 may determine one transfer coil for transferring the wireless power to the receiver coil among the plurality of transfer coils on the basis of the size of the receiver coil. The plurality of transfer coils may be disposed on the same plane in a horizontal direction.

The communication unit 1501 may receive information on the size of the receiver coil from the wireless power receiver. The control unit 1502 may determine the one transfer coil on the basis of the information on the size of the receiver coil.

The control unit 1502 may determine an amount of wireless power to be transferred to the wireless power receiver. The control unit 1502 may generate information on the determined amount of wireless power. The communication unit 1501 may transmit the information on the amount of wireless power to the wireless power receiver.

The communication unit 1501 may receive information on the size of the receiver coil from the wireless power receiver. The control unit 1502 may determine the one transfer coil on the basis of the information on the size of the receiver coil. The information on the size of the receiver coil may be information on the size of one of the plurality of receiver coils determined by the wireless power receiver on the basis of the information on the amount of wireless power.

FIG. 16 is a flowchart illustrating an operation of the wireless power transmitter according to an embodiment.

The wireless power transmitter may transmit and receive identification information to and from the wireless power receiver. The wireless power transmitter may identify the wireless power receiver. The wireless power transmitter may transfer and receive the wireless power to and from the wireless power receiver. The wireless power transmitter may end the wireless power receiver.

Referring to FIG. 16, the wireless power transmitter according to an embodiment may transfer the wireless power through the following processes.

The wireless power transmitter may detect a size of the receiver coil of the wireless power receiver. According to an embodiment, the wireless power transmitter may receive information on the size of the receiver coil (S1601 step). According to another embodiment, the wireless power transmitter may determine an amount of wireless power to be transferred to the wireless power receiver. The wireless power transmitter may generate information on the determined amount of wireless power. The wireless power transmitter may transmit the information on the amount of wireless power to the wireless power receiver.

Here, the wireless power receiver may determine one coil of the plurality of receiver coils on the basis of the information on the amount of wireless power (S1602 step). The wireless power receiver may transmit the information on the determined receiver coil to the wireless power transmitter. The wireless power transmitter may determine one coil of the plurality of transfer coils on the basis of the information on the receiver coil.

The wireless power transmitter may transfer the wireless power to the wireless power receiver through one transfer coil.

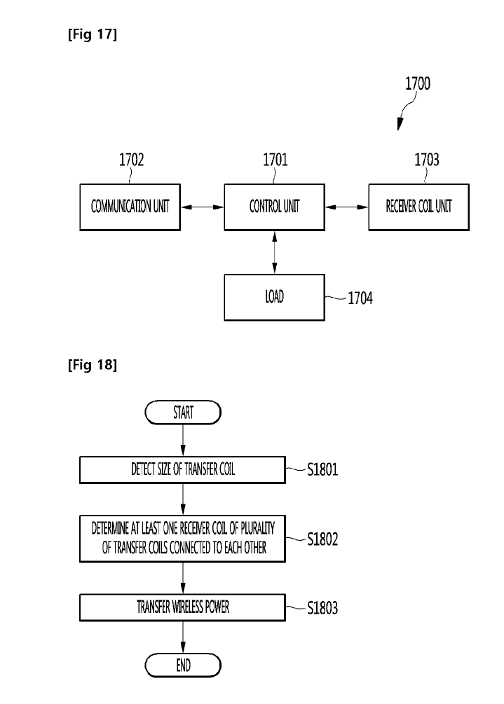

FIG. 17 is a view of a wireless power receiver according to an embodiment.

Referring to FIG. 17, a wireless power receiver 1700 may include a control unit 1701, a communication unit 1702, a receiver coil unit 1703, and a load 1704.

The receiver coil unit 1703 may include a plurality of transfer coils, which are connected to each other to form one body and have sizes different from each other. The control unit 1701 may detect a size of a transfer coil of a wireless power transmitter. The control unit 1701 may determine one receiver coil for receiving the wireless power to the transfer coil among the plurality of receiver coils on the basis of the size of the transfer coil. The plurality of receiver coils may be disposed on the same plane in a horizontal direction.

The communication unit 1702 may transmit information on the size of the transfer coil from the wireless power transmitter. The control unit 1701 may determine the at least one receiver coil on the basis of the information on the size of the transfer coil.

According to another embodiment, the control unit 1701 may determine an amount of wireless power to be received. The control unit 1701 may generate information on the determined amount of wireless power. The communication unit 1702 may transmit the information on the amount of wireless power to the wireless power transmitter. The communication unit 1702 may transmit information on the size of the transfer coil from the wireless power transmitter. The control unit 1701 may determine the one receiver coil on the basis of the information on the size of the transfer coil. The information on the size of the transfer coil may be information on the size of one of the plurality of transfer coils determined by the wireless power transmitter on the basis of the information on the amount of wireless power.

FIG. 18 is a flowchart illustrating an operation of the wireless power receiver according to an embodiment.

Referring to FIG. 18, the wireless power receiver may determine a size of the transfer coil of the wireless power transmitter 1000. According to another embodiment, the wireless power receiver may receive information on the size of the transfer coil from the wireless power transmitter.

The wireless power receiver may determine one receiver coil of the plurality of receiver coils connected to each other (S1802 step). According to an embodiment, the wireless power receiver may include a plurality of receiver coils, which are connected to each other to form one body and have sizes different from each other. The wireless power receiver may detect a size of the transfer coil of the wireless power transmitter. The wireless power receiver may determine one receiver coil for receiving the wireless power to the transfer coil among the plurality of receiver coils on the basis of the size of the transfer coil.

According to another embodiment, the wireless power receiver may determine one receiver coil of the plurality of receiver coils on the basis of information on a size of the transfer coil, which is received from the wireless power transmitter.

According to further another embodiment, the wireless power receiver may determine an amount of wireless power to be received. The wireless power receiver may generate information on the determined amount of wireless power. The wireless power receiver may transmit the information on the amount of wireless power to the wireless power transmitter. Here, the wireless power transmitter may determine one transfer coil for transferring the wireless power to the wireless power receiver among the plurality of transfer coils on the basis of the information on the amount of wireless power. The wireless power receiver may transmit information on the size of the transfer coil from the wireless power transmitter. The wireless power receiver may determine the one receiver coil on the basis of the information on the size of the transfer coil.

The wireless power receiver may receive the wireless power from the wireless power transmitter through the determined one receiver coil.

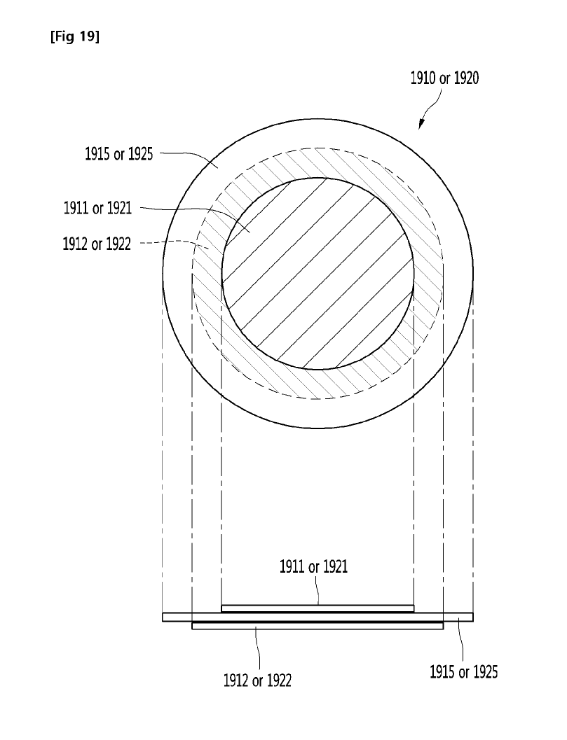

FIG. 19 is top and side views of the transfer coil unit or the receiver coil unit according to embodiment.

Referring to FIG. 19, a transfer coil unit 1910 according to an embodiment may include a plurality of transfer coils 1911 to 1912, which have sizes different from each other. For example, the transfer coil unit 1910 may include a first transfer coil 1911 and a second transfer coil 1912, each of which has a circular shape. Here, the first transfer coil 1911 may have a size less than that of the second transfer coil 1912. The transfer coil unit 1910 may include a printed circuit board 1915 disposed between the plurality of transfer coils 1911 and 1912. The printed circuit board 1915 may have a size that exceeds that of each of the plurality of transfer coils 1911 and 1912. According to another embodiment, the plurality of transfer coils 1911 and 1912 may be disposed to be vertically laminated on one surface of the printed circuit board 1915.

The receiver coil unit 1920 according to an embodiment may include a plurality of receiver coils 1921 to 1922, which have sizes different from each other. For example, the receiver coil unit 1920 may include a first receiver coil 1921 and a second transfer coil 1922, each of which has a circular shape. Here, the first receiver coil 1921 may have a size less than that of the second receiver coil 1922. The receiver coil unit 1920 may include a printed circuit board 1925 disposed between the plurality of receiver coils 1921 and 1922. The printed circuit board 1925 may have a size that exceeds that of each of the plurality of receiver coils 1921 and 1922.

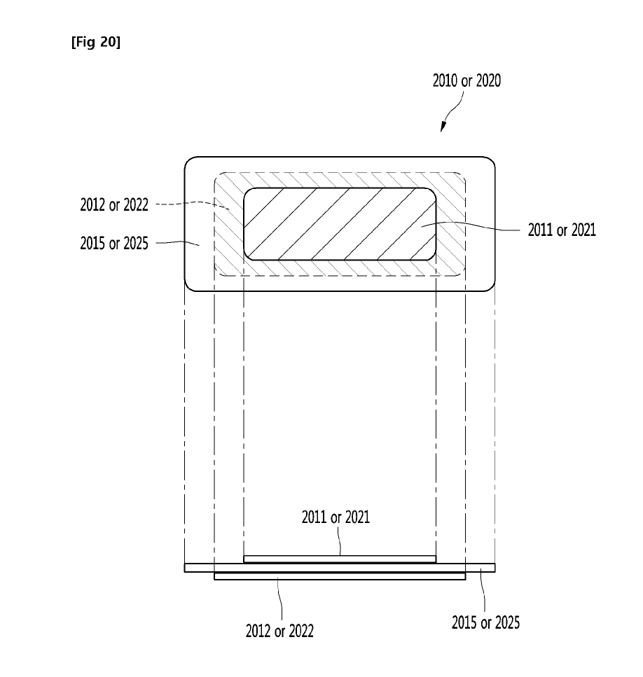

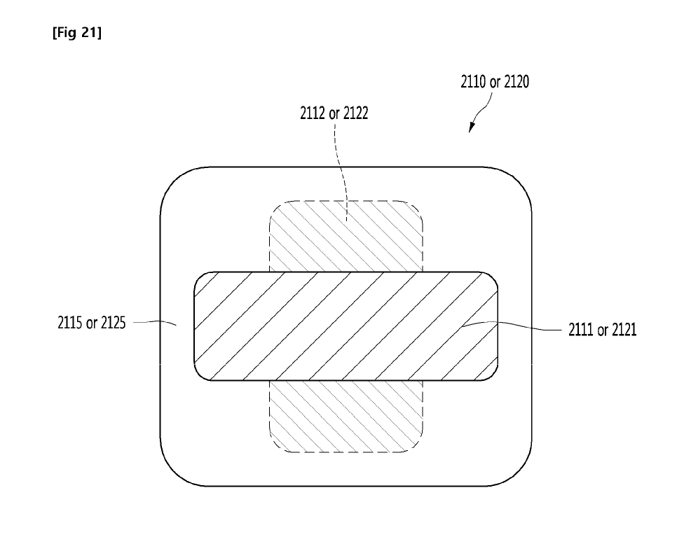

FIG. 20 is top and side views of the transfer coil unit or the receiver coil unit according to another embodiment.

Referring to FIG. 20, a transfer coil unit 2010 according to an embodiment may include a plurality of transfer coils 2011 to 2012, which have sizes different from each other. For example, the transfer coil unit 2010 may include a first transfer coil 2011 and a second transfer coil 2012, each of which has a circular shape. Here, the first transfer coil 2011 may have a size less than that of the second transfer coil 2012. The transfer coil unit 2010 may include a printed circuit board 2015 disposed between the plurality of transfer coils 2011 and 2012. The printed circuit board 2015 may have a size that exceeds that of each of the plurality of transfer coils 2011 and 2012. According to another embodiment, the plurality of transfer coils 2011 and 2012 may be disposed to be vertically laminated on one surface of the printed circuit board 2015. According to an embodiment, each of the plurality of transfer coils 2011 and 2012 may have a square shape. Also, each of the plurality of receiver coils 2021 and 2022 may have a square shape.

FIG. 21 is a top view of a transfer coil unit or a receiver coil unit according to further another embodiment.

Referring to FIG. 21, a transfer coil unit 2110 according to further another embodiment may include a plurality of transfer coils 2111 to 2112. Similarly, the receiver coil unit 2120 may include a plurality of receiver coils 2121 and 2122, which have sizes different from each other.

For example, the transfer coil unit 2110 may include a first transfer coil 2111 having a rectangular shape that extends in a transverse direction and a second transfer coil 2112 having a rectangular shape that extends in a longitudinal direction. Also, the receiver coil unit 2120 may include a first receiver coil 2121 having a rectangular shape that extends in a transverse direction and a second receiver coil 2122 having a rectangular shape that extends in a longitudinal direction.

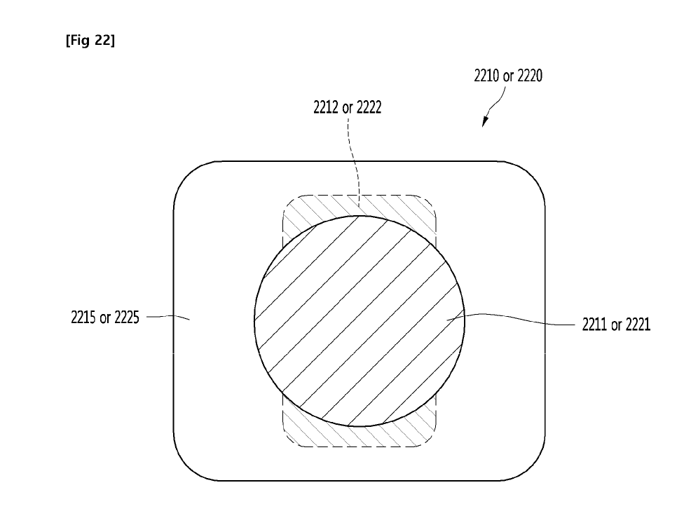

FIG. 22 is a top view of the transfer coil unit or the receiver coil unit according to further another embodiment.

Referring to FIG. 22, a transfer coil unit 2210 according to further another embodiment may include a plurality of transfer coils 2211 to 2212, which have different sizes and different shapes. Similarly, the receiver coil unit 2220 may include a plurality of receiver coils 2221 and 2222, which have sizes different from each other.

For example, the transfer coil unit 2210 may include a first transfer coil 2211 having a circular shape and a second transfer coil 2212 having a rectangular shape. The first transfer coil 2211 may have a diameter that exceeds that of one side of the second transfer coil 2212. According to further another embodiment, the first transfer coil 2211 may have a diameter less than that of one side of the second transfer coil 2212.

Also, the receiver coil unit 2220 may include a first receiver coil 2221 having a circular shape and a second receiver coil 2222 having a rectangular shape. The first receiver coil 2221 may have a diameter that exceeds that of one side of the second receiver coil 2222. According to further another embodiment, the first receiver coil 2221 may have a diameter less than that of one side of the second receiver coil 2222.

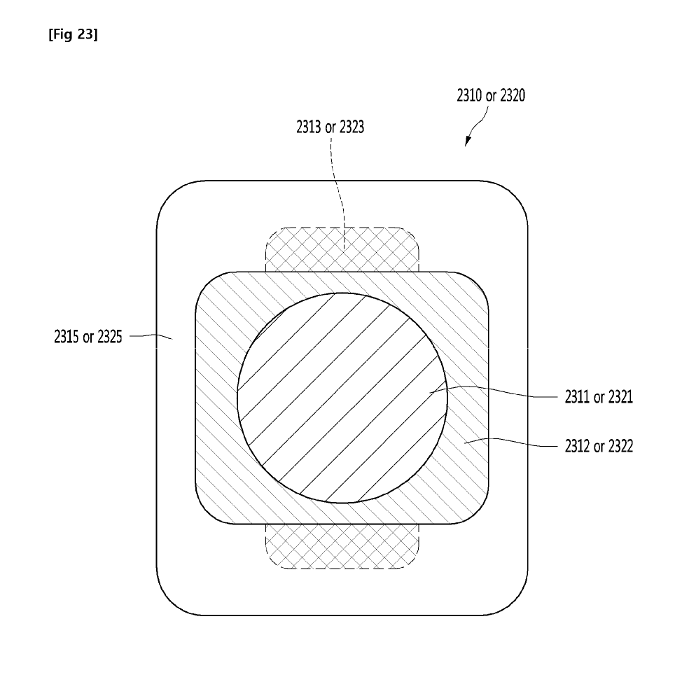

FIG. 23 is a top view of a transfer coil unit or a receiver coil unit according to further another embodiment.

Referring to FIG. 23, a transfer coil unit 2310 according to further another embodiment may include a plurality of transfer coils 2311 to 2312. Similarly, the receiver coil unit 2320 may include a plurality of receiver coils 2321 and 2322, which have sizes different from each other.

For example, the transfer coil unit 2310 may include a first transfer coil 2312 having a circular shape, a second transfer coil 2312 having a rectangular shape that extends in a transverse direction, and a third transfer coil 2313 having a rectangular shape that extends in a longitudinal direction. Also, the receiver coil unit 2320 may include a first receiver coil 2322 having a circular shape, a second receiver coil 2322 having a rectangular shape that extends in a transverse direction, and a third receiver coil 2323 having a rectangular shape that extends in a longitudinal direction. According to further another embodiment, the plurality of transfer coils 2311 to 2313 may have sizes different from each other. Also, the plurality of receiver coils 2321 to 2323 may have sizes different from each other.

FIG. 24 is a side view of the transfer coil unit or the receiver coil unit according to further another embodiment.

Referring to FIG. 24, a transfer coil unit 2410 according to an embodiment may include a plurality of transfer coils 2411 to 2414. Here, the receiver coil unit 2420 may be provided as one coil. According to another embodiment, the plurality of transfer coils 2411 to 2414 may have different shapes, different sizes, different arrangement orders.

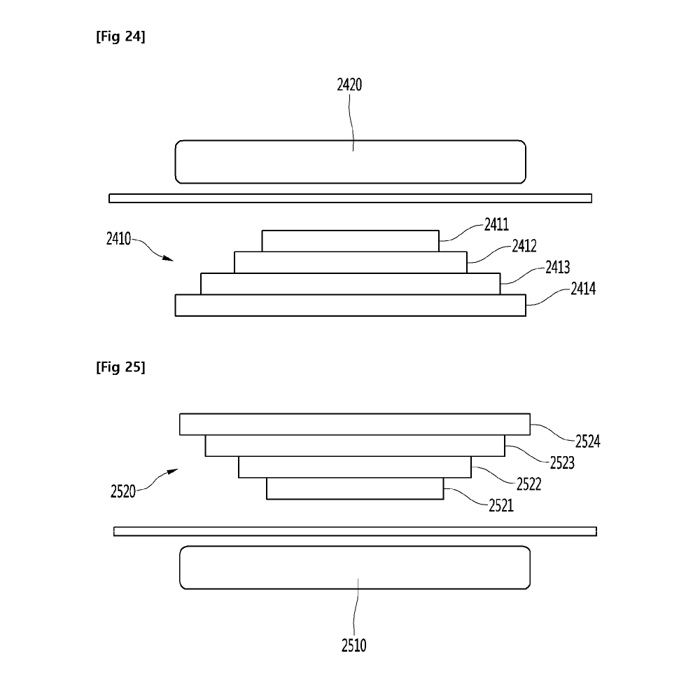

FIG. 25 is a side view of the transfer coil unit or the receiver coil unit according to further another embodiment.

Referring to FIG. 25, a receiver coil unit 2520 according to an embodiment may include a plurality of receiver coils 2521 to 2524. Here, the transfer coil unit 2510 may be provided as one coil. According to another embodiment, the plurality of receiver coils 2521 to 2524 may have different shapes, different sizes, different arrangement orders.

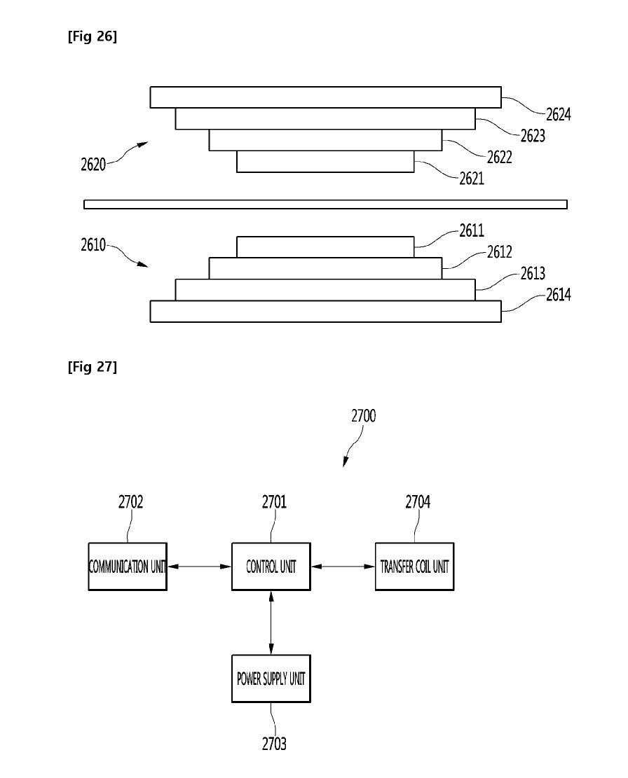

FIG. 26 is a side view of the transfer coil unit or the receiver coil unit according to further another embodiment.

Referring to FIG. 26, a transfer coil unit 2610 according to an embodiment may include a plurality of transfer coils 2611 to 2614. Also, the receiver coil unit 2620 may include a plurality of receiver coils 2621 to 2624. According to another embodiment, the plurality of transfer coils 2611 to 2614 may have different shapes, different sizes, different arrangement orders. Also, the plurality of receiver coils 2621 to 2624 may have different shapes, different sizes, different arrangement orders.

FIG. 27 is a view of a wireless power transmitter according to another embodiment.

Referring to FIG. 27, the wireless power transmitter 2700 according to an embodiment may include a control unit 2701, a communication unit 2702, a power supply unit 2703, and a transfer coil unit 2704.

The transfer coil unit 2704 may include a plurality of transfer coils, which have sizes different from each other. The control unit 2701 may detect a size of a receiver coil of a wireless power receiver. The control unit 2701 may determine one transfer coil for transferring the wireless power to the receiver coil among the plurality of transfer coils on the basis of the size of the receiver coil. The plurality of transfer coils may be disposed to be laminated vertically. The plurality of transfer coils may have the same shape or shapes different from each other.

The communication unit 2702 may receive information on the size of the receiver coil from the wireless power receiver. The control unit 2701 may determine the one transfer coil on the basis of the information on the size of the receiver coil. The transfer coil unit 2704 may further include a printed circuit board disposed between the plurality of transfer coils.

The control unit 2701 may determine an amount of wireless power. The control unit 2701 may generate information on the determined amount of wireless power. The communication unit 2702 may transmit the information on the amount of wireless power to the wireless power receiver.

The communication unit 2702 may receive information on the size of the receiver coil from the wireless power receiver. The control unit 2701 may determine the one transfer coil on the basis of the information on the size of the receiver coil. The information on the size of the receiver coil may include information on the size of one of the plurality of receiver coils determined by the wireless power receiver on the basis of the information on the amount of wireless power.

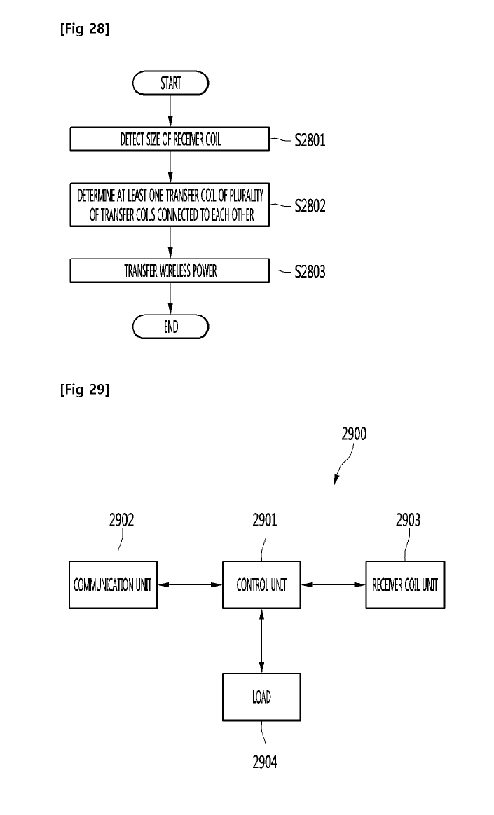

FIG. 28 is a flowchart illustrating an operation of the wireless power transmitter according to another embodiment.

The wireless power transmitter may transmit and receive identification information to and from the wireless power receiver. The wireless power transmitter may identify the wireless power receiver. The wireless power transmitter may transfer and receive the wireless power to and from the wireless power receiver. The wireless power transmitter may end the wireless power receiver.

The wireless power transmitter according to an embodiment may transfer the wireless power as described below.

Referring to FIG. 28, the wireless power transmitter may detect a size of the receiver coil of the wireless power receiver. According to an embodiment, the wireless power transmitter may receive information on the size of the receiver coil from the wireless power receiver.

According to another embodiment, the wireless power transmitter may previously determine an amount of wireless power to be transferred to the wireless power receiver. Here, the wireless power transmitter may generate information on the determined amount of wireless power. The wireless power transmitter may transmit the information on the amount of wireless power to the wireless power receiver. The wireless power receiver may determine a size of the receiver coil on the basis of the information on the amount of wireless power. The wireless power receiver may receive information on the size of the determined receiver coil on the basis of the information on the amount of wireless power.

The wireless power transmitter may determine one transfer coil of the plurality of transfer coils on the basis of the information on the size of the receiver coil (S2802 step). The wireless power transmitter may include a plurality of transfer coils, which have sizes different from each other. The plurality of transfer coils may be disposed to be laminated vertically. The plurality of transfer coils may have the same shape or shapes different from each other. The wireless power transmitter may determine the one transfer coil on the basis of the information on the size of the receiver coil.

The wireless power transmitter may transfer the wireless power to the wireless power receiver through one transfer coil (S2803 step).

FIG. 29 is a view of a wireless power receiver according to another embodiment.

Referring to FIG. 29, a wireless power receiver 2900 may include a control unit 2901, a communication unit 2902, a receiver coil unit 2903, and a load 2904.

The receiver coil unit 2903 may include a plurality of receiver coils, which have sizes different from each other. The control unit 2901 may detect a size of a transfer coil of a wireless power transmitter. The control unit 2901 may determine one receiver coil for receiving the wireless power to the transfer coil among the plurality of receiver coils on the basis of the size of the transfer coil. According to an embodiment, the plurality of transfer coils may be disposed to be laminated vertically. The plurality of receiver coils may have the same shape or shapes different from each other.

The communication unit 2902 may transmit information on the size of the transfer coil from the wireless power transmitter. The control unit 2901 may determine the at least one receiver coil on the basis of the information on the size of the transfer coil. The receiver coil unit 2903 may further include a printed circuit board disposed between the plurality of receiver coils.

The control unit 2901 may determine an amount of wireless power to be received. The control unit 2901 may generate information on the determined amount of wireless power.

The communication unit 2902 may transmit the information on the amount of wireless power to the wireless power transmitter. The communication unit 2902 may transmit information on the size of the transfer coil from the wireless power transmitter. The control unit 2901 may determine the one receiver coil on the basis of the information on the size of the transfer coil. The information on the size of the transfer coil may include information on the size of one of the plurality of transfer coils determined by the wireless power transmitter on the basis of the information on the amount of wireless power.

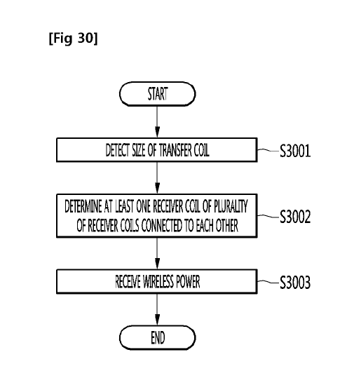

FIG. 30 is a flowchart illustrating an operation of the wireless power receiver according to further another embodiment.

Referring to FIG. 30, the wireless power receiver according to an embodiment may detect a size of the transfer coil of the wireless power transmitter. According to an embodiment, the wireless power receiver may receive information on the size of the transfer coil from the wireless power transmitter. According to another embodiment, the wireless power receiver may determine an amount of wireless power to be received. The wireless power receiver may generate information on the determined amount of wireless power. The wireless power receiver may transmit the information on the amount of wireless power to the wireless power transmitter. The wireless power transmitter may determine one transfer coil of the plurality of transfer coils on the basis of the information on the amount of wireless power. The wireless power transmitter may transmit the information on the one transfer coil to the wireless power receiver. The wireless power receiver may determine one receiver coil of the plurality of receiver coils on the basis of the information on the one coil.

The wireless power receiver may determine one receiver coil of the plurality of receiver coils (S3002 step). The wireless power receiver may include a plurality of receiver coils, which have sizes different from each other. The plurality of receiver coils may be disposed to be laminated vertically. The plurality of receiver coils may have the same shape or shapes different from each other. The wireless power receiver may determine at least one receiver coil on the basis of the information on the size of the transfer coil.

The wireless power receiver may receive the wireless power from the wireless power transmitter through the determined one receiver coil (S3003 step).

### INDUSTRIAL APPLICABILITY

The present invention may be used in the wireless power transfer and receiver fields.

1-26. (canceled)

27. A wireless power transmitter comprising:
a power supply unit;
a transfer coil unit comprising a plurality of transfer coils having sizes different from each other; and
a control unit configured to detect a size of a receiver coil of a wireless power receiver and determine one transfer coil for transferring the wireless power to the receiver coil among the plurality of transfer coils on the basis of the size of the receiver coil.

28. The wireless power transmitter of claim 27, wherein the plurality of transfer coils are connected to each other to form one body, and the plurality of transfer coils are disposed on the same plane in a horizontal direction.

29. The wireless power transmitter of claim 27, further comprising a communication unit configured to receive information on the size of the receiver coil from the wireless power receiver,
wherein the control unit determines the one transfer coil on the basis of the information on the size of the receiver coil.

30. The wireless power transmitter of claim 27, wherein the control unit determines an amount of wireless power and generates information on the determined amount of wireless power, and
wherein the communication unit transmits the information on the amount of wireless power to the wireless power receiver.

31. The wireless power transmitter of claim 29, wherein the communication unit receives information on the size of the receiver coil from the wireless power receiver,
wherein the control unit determines the one transfer coil on the basis of the information on the size of the receiver coil, and
wherein the information on the size of the receiver coil is one receiver coil of the plurality of receiver coils determined based on the information on the amount of wireless power.

32. The wireless power transmitter of claim 27, wherein the plurality of transfer coils are disposed to be laminated in a vertical direction.

33. The wireless power transmitter of claim 27, wherein the plurality of transfer coils have the same shape or shapes different from each other.

34. The wireless power transmitter of claim 27, further comprising a communication unit configured to receive information on the size of the receiver coil from the wireless power receiver,
wherein the control unit determines the one transfer coil on the basis of the information on the size of the receiver coil.

35. The wireless power transmitter of claim 27, wherein the transfer coil unit further comprises a printed circuit board disposed between the plurality of transfer coils.

36. The wireless power transmitter of claim 27, wherein the control unit determines an amount of wireless power and generates information on the determined amount of wireless power, and
wherein the communication unit transmits the information on the amount of wireless power to the wireless power receiver.

37. The wireless power transmitter of claim 36, wherein the communication unit receives information on the size of the receiver coil from the wireless power receiver,
wherein the control unit determines the one transfer coil on the basis of the information on the size of the receiver coil, and
wherein the information on the size of the receiver coil is one receiver coil of the plurality of receiver coils determined based on the information on the amount of wireless power.

38. A wireless power receiver comprising:
a receiver coil unit comprising a plurality of receiver coils having sizes different from each other; and
a control unit configured to detect a size of a transfer coil of the wireless power transmitter and determine one receiver coil for receiving the wireless power from the transfer coil among the plurality of receiver coils on the basis of the size of the transfer coil.

39. The wireless power receiver of claim 38, wherein the plurality of receiver coils are connected to each other to form one body, and the plurality of receiver coils are disposed on the same plane in a horizontal direction.

40. The wireless power receiver of claim 38, further comprising a communication unit configured to receive information on the size of the transfer coil from the wireless power transmitter,
wherein the control unit is configured to determine the one receiver coil on the basis of the information on the size of the transfer coil.

41. The wireless power receiver of claim 38, wherein the control unit determines an amount of wireless power to be received and generates information on the determined amount of wireless power, and
wherein the communication unit transmits the information on the amount of wireless power to the wireless power transmitter.

42. The wireless power receiver of claim 41, wherein the communication unit receives information on the size of the transfer coil from the wireless power transmitter,
wherein the control unit determines the one receiver coil on the basis of the information on the size of the transfer coil, and
wherein the information on the size of the transfer coil is one transfer coil of the plurality of transfer coils determined based on the information on the amount of wireless power.

43. The wireless power receiver of claim 38, wherein the plurality of receiver coils are disposed on the same plane in a horizontal direction, and the plurality of receiver coils have the same shape or shapes different from each other.

44. The wireless power receiver of claim 38, further comprising a communication unit configured to receive information on the size of the transfer coil from the wireless power transmitter,
wherein the control unit determines the one receiver coil on the basis of the information on the size of the transfer coil,
wherein the receiver coil unit further comprises a printed circuit board disposed between the plurality of receiver coils,
wherein the control unit determines an amount of wireless power to be received and generates information on the determined amount of wireless power,
wherein the communication unit transmits the information on the amount of wireless power to the wireless power transmitter,
wherein the communication unit receives information on the size of the transfer coil from the wireless power transmitter,
wherein the control unit determines the one receiver coil on the basis of the information on the size of the transfer coil, and
wherein the information on the size of the transfer coil is one transfer coil of the plurality of transfer coils determined based on the information on the amount of wireless power.

45. A method for operating a wireless power transmitter comprising:
transmitting and receiving identification information to and from a wireless power receiver;
identifying the wireless power receiver;
transferring the wireless power to the wireless power receiver; and
ending the wireless power transfer,
wherein the transferring the wireless power comprises:
detecting a size of a receiver coil of the wireless power receiver;
determining one transfer coil of a plurality of transfer coils, which are connected to each other to form one body and have sizes different from each other, on the basis of the size of the receiver coil; and
transferring the wireless power to the wireless power transmitter through the one transfer coil.

46. The method of claim 45, wherein the plurality of transfer coils are connected to each other to form one body.
